(19) United States
(12) Patent Application Publication
(10) Pub. No.: US 2010/0252212 A1
(43) Pub. Date: Oct. 7, 2010

(54) Covering System

(75) Inventors: Cutler Daniel, Geneva (CH); Dvir Brand, Kfar Saba (IL)

Correspondence Address: SUTHERLAND ASBILL & BRENNAN LLP, 999 PEACHTREE STREET, N.E., ATLANTA, GA, 30309, US

(73) Assignee: Daniel Cutler, Geneva (CH)

(21) Appl. No.: 12/663,589

(22) PCT Filed: Jun. 12, 2008
(86) PCT No.: PCT/GB2008/002033

§ 371 Date: Apr. 16, 2010

(30) Foreign Application Priority Data
Jun. 12, 2007 (GB) 0711338.4
Apr. 14, 2008 (GB) 0806739.9

(51) Int. Cl. E06B 9/24; E04F 10/02; A47H 1/18

(52) U.S. Cl. 160/368.1; 160/382; 160/383

(57) ABSTRACT

A retractable covering system including a screen that is movable between a retracted and an extended configuration and at least two tensioning members attached to a leading edge of the screen and arranged to pull the screen in opposite transverse directions so as to create transverse tension in the screen.

The invention relates to a retractable covering apparatus such as a canopy or an awning for covering an outdoor area such as a patio, garden, play area or swimming pool.

Awnings or canopies are often used for example outside restaurants or in private gardens to cover open areas and provide shelter for the people underneath them, thereby providing sun protection, rain protection or the like.

Many different types of covering system are known, but most systems are limited in size because of the tension which they are capable of providing and maintaining in the screen. It is important to keep canopies or awnings taut when extended in order to avoid sagging of the screen and also to prevent undue swaying or flapping of the screen in the wind.

Tension must be imparted to the screen both longitudinally (i.e. in the direction of extension) and transversely (i.e. perpendicular to the direction of extension). This becomes particularly crucial when large screens are involved due to the large weight of the screen material which tends to make the screen sag.

Traditional mechanical folding arm canopies have a mechanical folding arm attached to each of the front (leading edge) corners of the screen and extend the screen by unfolding the arms. Such systems can provide transverse tension in the screen by having both arms pushing outwardly in opposite transverse directions. Longitudinal tension is normally provided by a spring which biases the canopy screen towards the retracted position. However, mechanical arm canopies have a limited range and cannot be used for larger covering systems, beyond about 3 to 4 metres in length.

One way of maintaining lateral tension in the canopy screen is to pretension the screen and then clamp the leading edge of the screen into a rigid bar. However, the rigid bar can add significant extra weight, particularly for a wide screen. This extra weight must be supported by the structure of the covering system which must be made correspondingly more sturdy. The bar may also be considered unsightly.

GB 2421522 describes a covering system in which the screen is extended and retracted along longitudinal cables and in which transverse support is provided by a transverse front bar fixed to the leading edge of the screen to prevent sagging.

According to the invention, there is provided a retractable covering system comprising: a screen which is movable between a retracted and an extended configuration; and tensioning members attached to a leading edge of the screen and arranged to pull the screen in opposite transverse directions so as to create transverse tension in the screen.

It is generally not sufficient to provide the tension in the screen only when it is in the deployed state. For example, if the screen is being retracted due to high wind conditions, it is important to keep the screen under tension throughout retraction to prevent the screen from getting caught by the wind. It is also necessary to keep the screen under tension during deployment and retraction if the screen is stored on a storage roller when not in use. If a large screen is wound up on or unwound from a storage roller while not under the proper tension, creases and wrinkles can develop in the screen. Such creases and wrinkles form weaknesses in the screen which can reduce the strength of the screen and its resistance to tearing. Preferably therefore, the tensioning members are capable of providing tension in the screen continually throughout the deployment and/or retraction of the screen.

The screen could have a pulling force applied at one transverse end and be fixed at the opposite transverse end so that a reaction force is provided. However, preferably pulling forces are applied to both transverse ends of the screen.

Having tensioning members pulling the screen outwardly in opposite transverse directions keeps the screen taut in the transverse direction. The amount of tension applied can easily be adjusted depending on the size of the screen and the conditions of use. For example more tension may be required in higher wind or if the screen is deployed (extended) during rain. The provision of tensioning members which pull the screen to create tension means that there is no longer any need for a cumbersome front bar at the leading edge of the screen. This reduces the overall weight which the system has to support and gives a more delicate, aesthetic appearance.

In larger screens, the tension required to keep the screen taut may be greater than the tear strength of the screen material. Therefore, preferably a reinforcing member is provided along the length of the leading edge of the screen between the attachment points of the tensioning members. The reinforcing strap is capable of withstanding a greater tension than the screen material and it therefore prevents the screen from tearing when a large transverse tension is applied to the screen via the tensioning members.

Preferably, the tensioning members are arranged to pull the screen longitudinally in the direction of extension as well as transversely so as to create longitudinal tension in the screen. In other words, the tensioning members are splayed outwardly with respect to the direction of extension of the screen. Tension forces applied to the tensioning members will have a longitudinal component and a transverse component. Both longitudinal components will pull the screen in the direction of extension (i.e. they act in the same direction) and the transverse components will create tension across the screen (i.e. they act in opposite directions). The rear (trailing edge) of the screen is fixed in place so that the longitudinal components create longitudinal tension in the screen. The screen may be fixed to supports, e.g. free standing supports, or a building facade. The screen may typically be attached at its rear end to a storage roller on which the screen can be wound up for storage, the roller being rotatably mounted to the supports.

The attachment points of the tensioning members to the screen can be anywhere along the leading edge of the screen. However, tension is only provided in the portion of the screen between the attachment points. Portions of the screen which are transversely outward of the attachment points will not be tensioned and may sag. Therefore, the further apart the attachment points are, the more of the screen will be under tension. Preferably therefore the tensioning members are attached to the corners of the leading edge of the screen. This arrangement puts substantially the whole screen under transverse tension.

The tensioning members may be rigid, but preferably they are flexible. More preferably, the tensioning members are wires or cables.

In one preferred embodiment of the invention, each tensioning member is connected at a first end to the screen and at a second end to a support and the distance between the second ends of the tensioning members is greater than the distance between the first ends of the tensioning members. In other words the tensioning members are splayed outwardly from the screen to the supports. In this system the screen is preferably extended by reeling in the tensioning members so as to draw the screen closer to the support. As the distance between the supports is greater than the distance between the attachment points of the tensioning members to the screen, the screen is continually under tension in the transverse direction at all times during its deployment and retraction and is maintained in tension when deployed at any chosen distance of extension. Where the tensioning members are cables, a winch may be used to wind the cables in, thus pulling the screen towards the supports. The tensioning members are therefore variable in length, getting shorter as the screen is extended and longer as the screen is retracted. Longitudinal tension is created by holding the screen at its trailing edge and pulling the leading edge of the screen in the direction of extension. Where the screen is provided on a storage roller, this may be achieved by braking or locking the storage roller. Alternatively, if the storage roller is motorised, the storage roller motor may be driven in reverse (i.e. in the retraction direction) while the winches are braked or locked in order to create tension.

As the screen is extended, the leading edge of the screen gets closer to the supports. Therefore the angle between the two tensioning members becomes greater. As the tensioning members become more splayed, the transverse components of the tension become greater and the longitudinal components of the tension are reduced. Therefore, as the screen is extended further, the transverse tension across the screen increases. This balances against the increasing weight of screen material as the screen is extended. As tension in the tensioning members is increased to compensate for the increased need for longitudinal tension, the transverse tension components are also correspondingly increased. The increasing weight gives a greater tendency to sag, but the increasing tension keeps the screen taut.

In another preferred embodiment of the invention, the covering system comprises longitudinal support elements. In this embodiment, the longitudinal support elements are fixed, extending from the rear of the area to be covered (the position of the leading edge of the screen when the screen is fully retracted) to the front of the area to be covered (the position of the leading edge of the screen when the screen is fully extended). The longitudinal support elements may serve as the tensioning members by movably mounting the screen to the longitudinal support elements. In such an arrangement, the longitudinal support elements are positioned either side of the screen so that the distance between the longitudinal support elements is greater than the width of the screen so that either the longitudinal support elements must bend to meet the screen or the screen must stretch to meet the longitudinal support elements. Either way, tension is provided across the screen. As the screen is moved with respect to the longitudinal support elements, the transverse tension is maintained.

Preferably, tensioning members are provided in addition to the longitudinal support members. A first end of each tensioning member is connected to the screen and a second end of each tensioning member is movably mounted to one of the longitudinal support elements. As the screen is mounted to the longitudinal support elements via the tensioning members which are splayed outwardly (because the distance between the support elements is greater than the distance between the attachment points to the screen), the screen is continually under tension in the transverse direction at all times during its deployment and retraction and is maintained in tension when deployed at any chosen distance of extension.

The longitudinal support members are preferably also splayed apart such that the distance between them at the rear of the area to be covered is less than the distance between them at the front of the area to be covered. In the case of the system having further tensioning members, as the screen is extended (i.e. as the tensioning members are moved along the support members in the extension direction), the angle between the tensioning members increases. As the tensioning members become more splayed; the transverse component of the tension becomes greater and the longitudinal component of the tension is reduced. Therefore, as the screen is extended further, the transverse tension across the screen increases. This balances against the increasing weight of screen material as the screen is extended.

Preferably, the second end of each tensioning member is mounted to its respective longitudinal support element via a roller which rolls along the longitudinal support member. This greatly reduces friction between the support element and the tensioning member. It is also possible with this arrangement to motorize the rollers for automatic extension and retraction. If a storage roller is provided, this may also be motorised.

In order to create longitudinal tension in the screen, the leading edge and the trailing edge of the screen can be pulled, respectively in the direction of extension or retraction, or one edge can be fixed while the other pulls against it. For example, the leading edge of the screen can be pulled in the extension direction or fixed to the longitudinal supports (e.g. by gripping or clamping) while the trailing edge of the screen is pulled in the direction of retraction (e.g. by winding the screen back onto a storage roller). Alternatively, the trailing edge of the screen can be fixed (e.g. by locking or braking the storage roller) while the trailing edge is pulled in the extension direction. Once tension has been created, both leading and trailing edges can be fixed in place in order to maintain that tension.

The longitudinal support elements may be rigid, e.g. a framework. However, rigid frameworks can be unsightly and cumbersome and therefore preferably the longitudinal support elements are flexible. More preferably they are ropes, wires or cables which are capable of withstanding the necessary tensioning forces.

Although the transverse tension created by the tensioning members will be sufficient for many covering systems, it can be advantageous to add transverse tension in other ways too. This becomes increasingly necessary as the size of the apparatus increases. As the screen size increases, so does the tension required to keep it sufficiently taut.

Extra transverse tension can be created in the screen in or near the fully deployed position by creating a difference in height between the front supports. If one front support is positioned higher off the ground than the other front support, then as the leading edge of the screen approaches the supports, it tilts to one side (away from the horizontal) and is stretched across a greater distance. A further advantage of this arrangement is that the screen naturally drains water towards the lower front corner, thus obviating any need for other drainage mechanisms. Drainage is not such a great problem in smaller canopies where the screen does not extend so far and can therefore slope downwards at a sufficient angle to allow water run-off, or where it is easy to provide sufficient tension to keep the screen taut. However, in larger canopies, where tension is difficult to provide and maintain and the angle of the canopy cannot be so great, water can pool on top of the screen causing it to sag, which in turn leads to further accumulation of water.

An alternative way of providing further tension (both transverse and longitudinal) in a generally rectangular screen is by arching the sides of the screen slightly inwards so that they are concave. In other words, the screen is not perfectly rectangular, but has sides which are curved from one corner, in towards the centre and back out to an adjacent corner. When tension is applied generally parallel to such a side of a screen, the force causes the curved fabric to try to straighten out. This causes tension to be applied in the direction substantially perpendicular to the direction in which the tension force is actually being applied. The perpendicular tension is dependent upon (and can therefore be controlled through) the parallel tension applied and the curvature of the side.

In one preferred embodiment, the shape of the screen fabric itself is not arched in this way, but arched straps are provided along the sides of the screen. The arched strap is fixed to the screen material, e.g. by gluing or sewing, so that when it is pulled and attempts to straighten, it pulls the screen material with it, thus creating tension in the screen perpendicular to the applied force.

One of the advantages of providing tension through arched edges or arched straps is that the perpendicular tension is applied along the whole side of the screen. For example if a longitudinal force is applied to the screen at one corner, the resulting transverse (perpendicular) force is applied to the screen not just at the corner, but along the whole longitudinal length of the screen.

It is possible for all four sides of the screen to be arched or provided with arched straps in this way. However, as one side of the retractable screen will be attached to a storage roller, there is generally no need to arch that side. Therefore preferably, three or fewer sides of the screen are arched. Most preferably, the front (leading edge) and the two side edges are arched. In this way, when tension is applied to the front corners of the screen, the two arched side edges pull in opposite directions, creating transverse tension throughout the screen and the arched leading edge pulls against the storage roller at the rear, thus creating longitudinal tension throughout the screen. Depending on the particular size and requirements of the awning, the screen may have various combinations of arched edges. For example the screen may only have arched side edges with the leading and trailing edges being substantially straight if longitudinal tension is not an issue. Similarly, the screen may only have arched leading and trailing edges with the side edges being substantially straight if transverse tension is not an issue. Alternatively, the screen may only have an arched leading edge and be substantially straight on the other three sides. Also, where the transverse tension is to be created, the screen may have only one arched side edge with the other side edge being substantially straight.

This concept is believed to be independently inventive and therefore, according to a further aspect, there is provided a retractable covering system comprising: a screen which is movable between a retracted and an extended configuration, at least one edge of the screen being adapted so that when tension is applied parallel to said edge, tension is generated substantially perpendicular to said edge.

As discussed above, preferably three or fewer edges are so adapted, most preferably the two side edges and the leading edge. Preferably the or each side is provided with an arched flexible member extending between the two corners which define the edge and which is fixed to the screen throughout its length. Most preferably, the flexible member is a strap. The flexible member may be fixed to the screen in any appropriate way, but it is most preferably glued or sewn to the screen.

Preferred embodiments of the invention will now be described by way of example only, and with reference to the accompanying drawings in which:

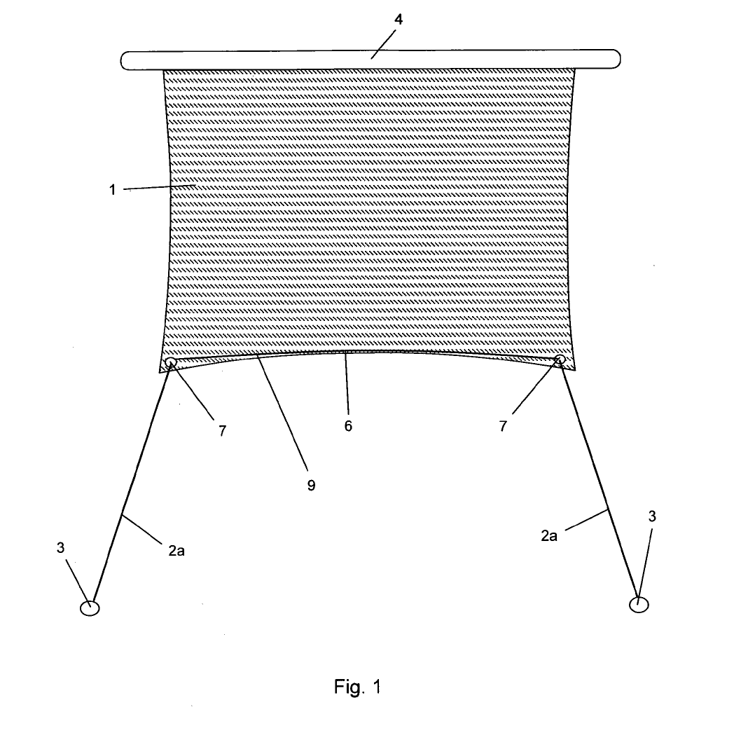

FIG. 1 shows a plan view of a first embodiment of the invention;

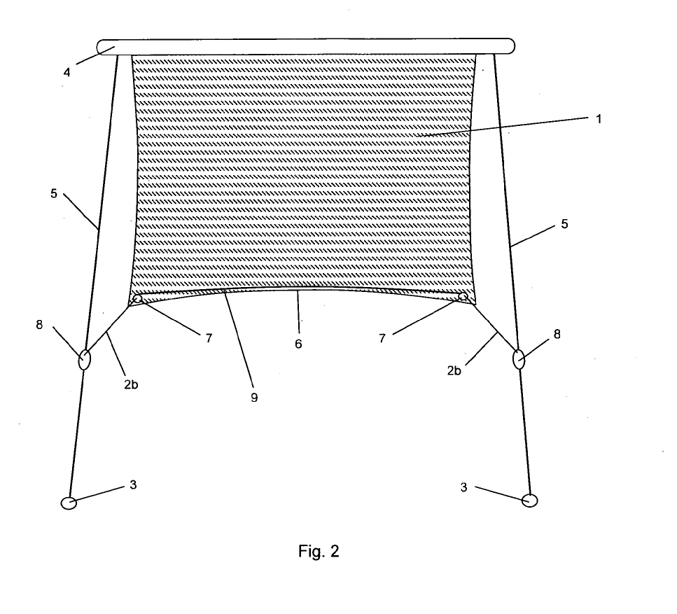

FIG. 2 shows a plan view of a second embodiment of the invention; and

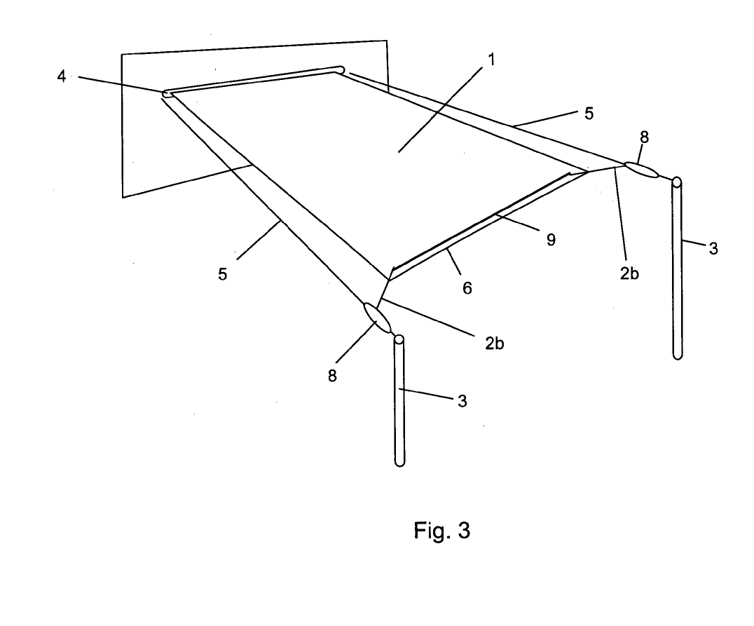

FIG. 3 shows a perspective view of a third embodiment of the invention.

FIGS. 1, 2 and 3 show three embodiments of the invention. The covering system of FIGS. 1, 2 and 3 has a screen 1 for covering an outdoor area. The covering system is designed to provide sun and/or rain protection over an outdoor area so that the area can be enjoyed by people during sunny or rainy weather. The screen is typically made from a flexible fabric material. When the screen 1 is retracted it is stored in a housing 4. The screen 1 is typically rolled up on one or more rollers (not shown) inside the housing to keep it out of the way.

To extend the screen 1, the leading edge 6 is pulled out and away from the housing 4 so as to unroll the screen and cover the desired area.

In the embodiment of FIG. 1, the screen is drawn out from the housing 4 by two tensioning members 2a. The tensioning members 2a are attached at one end (first end) to the screen 1 at attachment points 7 at the corners of the screen 1, and at the other end (second end) to supports 3. The supports 3 may be for example a wall (facade) of a building or posts buried in the ground. The attachment points 7 may, for example, be eyelets.

The distance between the supports 3 is greater than the distance between the attachment points 7 on the screen 1. Therefore the tensioning members 2a which extend from the attachment points 7 to the supports 3 are splayed outwardly in the direction of extension of the screen 1.

In this embodiment, the tensioning members 2a are flexible cables and the supports 3 are provided with a winch (not shown) and a drum (not shown). When the winch is activated, the cables 2a are either wound up onto the drum (when the screen 1 is being extended) or unwound from the drum (when the screen 1 is being retracted). In this way the effective length of the cables 2a is decreased during extension and increased during retraction. During retraction, the storage roller inside the housing 4 is driven to reel in the screen.

As the screen 1 is extended, the angle between the tensioning member 2a and the leading edge 6 of the screen 1 increases. In other words, the angle between the two tensioning members 2a increases and they become more splayed.

If the tension in the tensioning members 2a stays constant during extension of the screen 1, then as the tensioning members 2a become more splayed, the transverse component of the tension (i.e. the component parallel with the leading edge 6 of the screen 1) increases, while the longitudinal component of the tension (i.e. the component parallel to the direction of extension of the screen 1) decreases. As the two transverse components of the two tensioning members 2a pull in opposite directions, the transverse tension in the screen 1 as a whole increases.

Longitudinal tension is created and maintained in the screen 1 by controlling the speed at which the screen 1 is payed out at the same time as controlling the speed at which the winches reel in the cables 2a. The resistive force of the screen roller at the rear of the screen 1 combined with the pulling force of the winches creates longitudinal tension in the screen 1.

It is also very important to maintain longitudinal tension in the screen 1 in order to avoid sagging of the screen 1. The covering system may therefore be arranged to maintain longitudinal tension in the screen 1. In this case, as the tensioning members 2a get splayed further apart as the screen 1 is extended, the overall tension in the tensioning members 2a must be increased so as to maintain the longitudinal component of the tension at the same level. However, this necessarily also means an increase in the transverse component of tension which increases relative to the longitudinal component as the angle between the cables 2a increases:

As long as tension is provided in the tensioning members 2a, there will be transverse components of that tension pulling the leading edge 6 of the screen 1 in opposite directions and thus creating tension in the screen 1. The screen 1 is therefore held in tension throughout its deployment and when the screen 1 has been deployed (extended) a desired amount (which could be any distance of extension from near fully retracted to fully extended), the screen 1 is maintained in tension, thus avoiding sagging of the screen 1.

As the level of transverse tension provided in the screen may be greater than the transverse tension which the screen material can withstand, a reinforcement member 9 is provided between the two attachment points 7 at the leading edge 6 of the screen 1. The reinforcement member 9 may be either a cable or a strap, but must be capable of withstanding the tension which will be provided transversely across the screen. The tensioning members 2a are attached to the reinforcement member 9 which is in turn attached to the screen 1. This prevents the screen 1 from being torn apart by the tension.

The embodiments of FIGS. 2 and 3 are similar to that of FIG. 1 and like elements are denoted by like reference numerals.

In the embodiment of FIG. 2, the covering system has two longitudinal support elements 5. In this embodiment, these longitudinal support elements 5 are flexible cables under high tension, but it is to be understood that rigid support elements could be used in other embodiments. Each flexible cable 5 extends from a support (not shown) at the rear of the covering system to a support 3 at the front of the covering system. Again, these supports may for example be the wall of a building or posts buried in the ground. These longitudinal support elements 5 provide vertical support for the screen 1 along the entire length of extension. As the support elements 5 are either rigid or under high tension (higher than the screen 1 can withstand), they are not so susceptible to sagging and can provide good support to the screen 1.

The screen 1 is connected to the longitudinal support elements 5 by tensioning members 2b. In this embodiment, tensioning members 2b are short flexible cables, although it is to be understood that rigid tension members such as rods could be used instead. The distance between the longitudinal support members 5 is greater than the distance between the attachment points 7 of the tensioning members 2b to the screen 1. Therefore the tensioning members 2b are splayed outwardly in the direction of extension of the screen 1.

At the other end (the second end) of the tensioning members 2b, the tensioning members 2b are mounted to the longitudinal support elements 5. In this embodiment, the tensioning members 2b are mounted to the support elements 5 by rollers 8 which roll along the support elements 5. The rollers 8 are motorised so that they can be driven relative to the support elements 5, thus pulling the screen 1 out from the housing 4 towards the supports 3 in the direction of extension. Each roller 8 comprises a case which houses at least one, preferably more than one roller wheel in contact with the support element 5.

As the rollers 8 pull the screen 1 in the direction of extension, tension is created in the tensioning members 2b. As the tensioning members 2b are splayed apart, the tension can be resolved into a transverse component (i.e. parallel with the leading edge 6 of the screen 1) and a longitudinal component (i.e. parallel to the direction of extension of the screen 1). As in the first embodiment, the longitudinal components add up to pull against the resistive force of the screen roller in the housing 4 and the transverse components are opposed so as to create transverse tension in the screen 1.

The longitudinal support elements 5 are also splayed apart in the direction of extension of the screen 1. They are closer together at the rear end of the covering system than they are at the front end of the covering system. The tensioning members 2b are of fixed length and therefore as the rollers 8 pull the tensioning members 2b and the screen 1 along the support elements 5 in the direction of extension, the increasing separation between the side of the screen 1 and the support elements 5 must be accommodated by a change in angle of the tensioning members 2b. As the screen 1 is extended, the angle between the tensioning member 2b and the leading edge 6 of the screen 1 increases. In other words, the angle between the two tensioning members 2b increases and they become more splayed.

As in the first embodiment, if the tension in the tensioning members 2b stays constant during extension of the screen 1, then as the tensioning members 2b become more splayed, the transverse component of the tension (i.e. the component parallel with the leading edge 6 of the screen 1) increases, while the longitudinal component of the tension (i.e. the component parallel to the direction of extension of the screen 1) decreases. As the two transverse components of the two tensioning members 2b pull in opposite directions, the transverse tension in the screen 1 as a whole increases. Also, the covering system may be arranged to maintain longitudinal tension in the screen 1. In this case, as the tensioning members 2b get splayed further apart as the screen 1 is extended, the overall tension in the tensioning members 2b must be increased so as to maintain the longitudinal component of the tension at the same level. This necessarily also means an increase in the transverse component of tension which increases relative to the longitudinal component as the angle between the tensioning members 2b increases.

As long as tension is provided in the tensioning members 2b, there will be transverse components of that tension pulling the leading edge 6 of the screen 1 in opposite directions and thus creating tension in the screen 1. The screen 1 is therefore held in tension throughout its deployment and when the screen 1 has been deployed (extended) a desired amount (which could be any distance of extension from near fully retracted to fully extended), the screen 1 is maintained in tension, thus avoiding sagging of the screen 1.

As in the first embodiment, a reinforcement member 9 is provided between the two attachment points 7 at the leading edge 6 of the screen 1. The reinforcement member 9 may be either a cable or a strap, but must be capable of withstanding the tension which will be provided transversely across the screen 1. The tensioning members 2b are attached to the reinforcement member 9 which is in turn attached to the screen 1. This prevents the screen 1 from being torn apart by the tension.

The screen 1 shown in FIGS. 1 and 2 is arched on three sides (the leading edge 6 and the two side edges). As a tensioning force is applied to the corners of the screen 1, through the tensioning members 2a, 2b, the arched sides of the screen 1 tend to straighten. This straightening causes a transverse tension in the screen to be created by the two side edges and a longitudinal tension in the screen to be created between the leading edge 6 and the storage roller in the housing 4. This keeps the whole screen sufficiently taut even for large screens.

The two side edges of the screen 1 are simply shaped into an arch to achieve this effect. However, the reinforcement member 9 on the leading edge 6 of the screen 1 is arched and is fixed to the screen 1 throughout its length. Therefore, as tension is applied transversely across the leading edge 6 of the screen 1, the reinforcement member 9 tends to straighten and pulls the screen 1 in the longitudinal direction, thus creating longitudinal tension throughout the width of the screen 1.

The embodiment shown in FIG. 3 is substantially the same as that shown in FIG. 2 and therefore description of like elements is omitted. The screen 1 in FIG. 3 does not have arched edges, but rather is rectangular. Transverse tension is created along the leading edge 6 of the screen 1 through the straight reinforcement member 9 and longitudinal tension is created by pulling the screen 1 against the force of the storage roller in the housing 4.

In FIG. 3, one of the support poles 3 (the one on the right as the figure is viewed) is slightly higher than the other. As the screen 1 is deployed, this height difference causes the leading edge 6 of the screen to tilt down to one side. This has the effect of enhancing the transverse tension in the screen 1 by increasing the distance between the support elements 5 and it also has the effect of creating a drainage path for water which falls onto the screen to flow towards the lower support pole 3, thus avoiding water pooling on the screen, with the associated resultant sag and increased need for tension.

We claim:

1. A retractable covering system comprising:
a screen which is movable between a retracted and an extended configuration; and
at least two tensioning members attached to a leading edge of the screen arranged to pull the screen in opposite transverse directions so as to create transverse tension in the screen, wherein the tensioning members are capable of providing tension in the screen continually throughout deployment and/or retraction of the screen.

2-21. (canceled)

22. A covering system as claimed in claim 1, wherein the tensioning members are arranged to provide adjustable tension in the screen.

23. A covering system as claimed in claim 1, wherein the system is arranged to increase or maintain the tension in the tensioning members as the screen is extended.

24. A covering system as claimed in claim 1, wherein the system is arranged to maintain longitudinal tension in the screen during extension.

25. A covering system as claimed in claim 1, wherein the tensioning members are arranged to pull the screen longitudinally in the direction of extension as well as transversely so as to create longitudinal tension in the screen.

26. A covering system as claimed in claim 1, wherein each tensioning member is connected at a first end to the screen and at a second end to a support and wherein the distance between the second ends of the tensioning members is greater than the distance between the first ends of the tensioning members.

27. A covering system as claimed in claim 1, wherein the tensioning members are attached to the corners of the leading edge of the screen.

28. A covering system as claimed in claim 1, wherein the tensioning members are flexible.

29. A covering system as claimed in claim 28, wherein the tensioning members are cables.

30. A covering system as claimed in claim 1, wherein the screen is extended by reeling in the tensioning members.

31. A covering system as claimed in claim 1, wherein the system is arranged to provide tension in the screen by controlling the speed at which the screen is paid out at the same time as controlling the speed at which the tensioning members are reeled in.

32. A covering system as claimed in claim 1, further comprising a winch arranged to wind in each of the tensioning members.

33. A covering system as claimed in claim 32, wherein each winch comprises a drum onto which the tensioning member can be wound.

34. A covering system as claimed in claim 1, further comprising longitudinal support elements, and wherein a first end of each tensioning member is connected to the screen and the second end of each tensioning member is movably mounted to one of the longitudinal support elements.

35. A covering system as claimed in claim 34, wherein the longitudinal support members are splayed apart such that the distance between them becomes greater in the direction of extension of the screen.

36. A covering system as claimed in claim 34, wherein the second end of each tensioning member is mounted to its respective longitudinal support element via a roller which rolls along the longitudinal support member.

37. A covering system as claimed in claim 34, wherein the longitudinal support elements are flexible cables.

38. A covering system as claimed in claim 1, further comprising a reinforcing member extending along the length of the leading edge of the screen between the attachment points of the tensioning members.

39. A covering system as claimed in claim 1, wherein at least one edge of the screen is adapted so that when tension is applied parallel to said edge, tension is generated substantially perpendicular to said edge.

40. A covering system as claimed in claim 39, wherein three or fewer edges are so adapted.

41. A covering system as claimed in claim 40, wherein the two side edges and the leading edge of the screen are so adapted.

42. A covering system as claimed in claim 39, wherein the or each side is provided with an arched flexible member extending between the two corners which define the side and which is fixed to the screen throughout its length.

43. A covering system as claimed in claim 42, wherein the flexible member is a strap, a cable or a cord.

44. A covering system as claimed in claim 42, wherein the flexible member is glued or sewn to the screen.

45. A retractable covering system comprising: a screen which is movable between a retracted and an extended configuration, at least one edge of the screen being adapted so that when tension is applied parallel to said edge, tension is generated substantially perpendicular to said edge.
